(19) United States
(12) Patent Application Publication
(10) Pub. No.: US 2015/0241364 A1
(43) Pub. Date: Aug. 27, 2015

(54) Inspecting Radiology Shields Using Passive RFID

(71) Applicant: WAKE FOREST UNIVERSITY HEALTH SCIENCES, Winston-Salem, NC (US)

(72) Inventors: Ronald A. Noel, Clemmons, NC (US); Eugene Stuart Grogan, Lexington, NC (US)

(21) Appl. No.: 14/431,988

(22) PCT Filed: Oct. 4, 2013
(86) PCT No.: PCT/US13/63490

§ 371 Date: Mar. 27, 2015

Related U.S. Application Data
(60) Provisional application No. 61/710,157, filed on Oct. 5, 2012.

(51) Int. Cl. G01N 23/06; G21F 3/02; G01M 99/00

(52) U.S. Cl. CPC G01N 23/06; G01M 99/008; G21F 3/02

(57) ABSTRACT

A method for locating/identifying and inspecting radiology shields to facilitate the safe use thereof is carried out by providing a set of radiology shields, each of the radiology shields having a unique identifier, and each of the radiology shields carrying a passive RFID tag, the passive RFID tag associated with the unique identifier; providing a central database, the database comprising common data and individual shield data; transmitting the common data and individual shield data for at least shields to be inspected to a portable RFID reader; identifying, with the portable RFID reader, shields to be inspected based on the inspection time interval and the data of last inspection; entering a determination of pass or fail inspection into the portable RFID reader for each of the shields to be inspected; and updating the central database individual shield data for each of the shields to be inspected from the portable RFID reader.

### BACKGROUND OF THE INVENTION

Radiology departments and other health care providers are required to inspect each radiology protective shield on a regular basis. Currently, annual inspections are required by The Joint Commission (One Renaissance Blvd., Oakbrook Terrace, Ill., USA 60181).

There are two difficult parts to the inspection process. First, shields must be located, and it must be determined whether each shield has been inspected within the appropriate time frame. After this, data must be entered into a medium that allows for easy data entry and provides quick access when needed to prove or demonstrate the inspection. These steps are complicated by the variety of different types of shields used within a particular facility, the easy portability and changing location of shields within a facility, the varied repair and/or replacement of shields, etc. Hence, there is a need for new systems and methods for locating and inspecting radiology shields.

### SUMMARY OF THE INVENTION

A first aspect of the invention is a computer-implemented method for locating (e.g., identifying) and inspecting radiology shields, comprising:
(a) providing a set of radiology shields, each of said radiology shields having a unique identifier thereon, and each of said radiology shields carrying a passive RFID tag, said passive RFID tag associated with said unique identifier;
(b) providing a central database, said database comprising common data and individual shield data, said common data comprising:
   (i) an inspection time interval for said radiology shields, and/or
   (ii) authorized users for said method;
      and said individual shield data comprising, for each of said radiology shields:
   (i′) the unique identifier for said radiology shield;
   (ii′) the RFID tag associated with said radiology shield;
   (iii′) a date of last inspection for said radiology shield; and/or
   (iv′) a pass or fail inspection determination for said radiology shield at said last inspection;
(c) transmitting said common data and individual shield data for at least shields to be inspected to a portable RFID reader;
(d) identifying, with said portable RFID reader, shields to be inspected based on said inspection time interval and said data of last inspection;
(e) entering a determination of pass or fail inspection into said portable RFID reader for each of said shields to be inspected; and then
(f) updating said central database individual shield data for each of said shields to be inspected from said portable RFID reader.

In some embodiments, the radiology shields are stored in a plurality of different locations within a common medical facility. In other embodiments, the radiology shields are stored in a plurality of different locations at a plurality of different medical facilities. In still other embodiments, the radiology shields are stored in both a plurality of different locations within a common medical facility, and a plurality of different locations at a plurality of different medical facilities.

In some embodiments, the common data further comprises:
(iii) pre-assigned locations for said radiology shields within a medical facility;
(iv) a set of types of radiology shields; and/or
(v) a set of inspection failure reasons.

In some embodiments, the shield data further comprises:
(v′) the last location of said radiology shield;
(vi′) the last inspector of said radiology shield; and/or
(vii′) the reason if any for a fail inspection determination for said radiology shield.

In some embodiments, the set of radiology shields comprise vests, skirts, aprons, apron sets, half aprons, gloves, goggles, glasses, face masks or screens, gonad shields, thyroid shields, or combinations thereof.

In some embodiments, the set of types comprises at least two of vests, skirts, aprons, apron sets, half aprons, gloves, goggles, glasses, face masks or screens, gonad shields, and thyroid shields.

In some embodiments, the set of inspection failure reasons comprises at least two, three or four of: rip/ripped, tear/torn, crack/cracked, burn/burned, stain/stained, cut, and hole/perforation.

In some embodiments, the transmitting step is carried out over wireless network, preferably a local area network.

Some embodiments further comprise the step of: (g) generating a report on said set of shields from said central database. In some embodiments the report comprises, for each of said shields: a date of last inspection for said radiology shield; and a pass or fail inspection determination for said radiology shields at said last inspection.

The foregoing and other objects and aspects of the present invention are explained in greater detail in the drawings herein and the specification below. The disclosures of all US Patent references cited herein are to be incorporated by reference herein in their entirety.

### BRIEF DESCRIPTION OF THE DRAWINGS

FIG. 1 is a schematic diagram of a system of the present invention.

FIG. 2 schematically illustrates method steps of a method of the present invention.

FIG. 3 is a schematic illustration of a first graphic display of a passive RFID reader of the present invention, in which a user identity may be chosen from a drop-down list, which drop-down list is transmitted to the reader from a central database.

FIG. 4 is a schematic illustration of a second graphic display of a passive RFID reader of the present invention, in which the user may choose inventory or manage.

FIG. 5 is a schematic illustration of a third graphic display of a passive RFID reader of the present invention, in which a set of shields to be inspected (or inventoried) by the user have been identified, and from which individual shields may be selected for entering a pass/faile determination.

FIG. 6 is a schematic illustration of a fourth graphic display of a passive RFID reader of the present invention, in which a pass or fail determination may be entered for a particular shield.

FIG. 7 is a schematic illustration of a fifth graphic display of a passive RFID reader of the present invention, in which a fail reason for a shield that has failed inspection may be entered.

FIG. 8 is a schematic illustration of a first graphic display of a controller of the present invention, in which the individual data for a specific shield in a central database may be viewed.

FIG. 9 is a schematic illustration of a second graphic display of a controller of the present invention, in which individual data for a plurality of shields in the central database may be viewed.

FIG. 10 is a schematic illustration of a third graphic display of a controller of the present invention, in which common data on authorized locations for radiology shields in the central database may be displayed, and from which new authorized locations may be created.

FIG. 11 is a schematic illustration of a fourth graphic display of a controller of the present invention, in which common data on authorized fail reasons for radiology shields in the central database may be entered, and from which new authorized fail reasons may be created.

FIG. 12 is a schematic illustration of a fifth display of a controller of the present invention, in which common data on authorized users for the inspection system in the central database and method may be displayed, and from which new authorized users or inspectors may be entered.

FIG. 13 is a schematic illustration of a sixth graphic display of a controller of the present invention, in which a time interval for inspections may be entered, so that data on only those radiology shields due for inspection is transmitted to the RFID reader. In this illustration, shields are due for inspection after 30 days.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety.

Also as used herein, “and/or” refers to and encompasses any and all possible combinations of one or more of the associated listed items, as well as the lack of combinations when interpreted in the alternative (“or”).

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any non-transient medium that can contain or store the program for use by or in connection with the instruction execution system, apparatus, or device.

The computer-usable or computer-readable medium may be, for example but not limited to, an electronic, magnetic, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM).

The present invention is described below with reference to block diagrams and/or flowchart illustrations of devices, methods and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

The present invention may be used to test, inventory, and generate reports on a variety of different types of radiology shields, including but not limited to vests (including breast and chest shields), skirts, aprons, apron sets, half aprons, gloves, goggles, glasses, face masks or screens, gonad shields, thyroid shields, full or partial leg shields (typically skirts, but optionally configured as slacks, chaps, etc.), hats and caps, etc., of any suitable size and/or configuration (e.g., for neonate, infant, juvenile, adolescent, adult, and geriatric subjects).

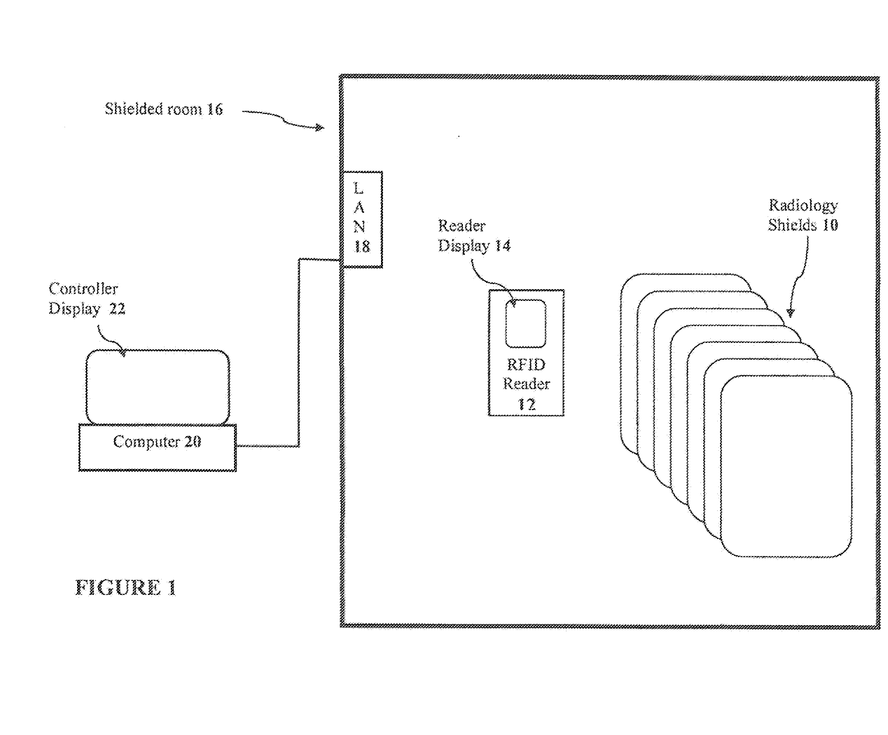

A non-limiting example of a system of the present invention is set forth in FIG. 1. As illustrated, the system comprises a plurality of radiology shields 10, each of which has a passive Radio Frequency Identification (RFID) tag connected thereto, such as by inserting it into the seam or binding of the radiology shield. The specific electronic identification, or “signature,” of the RFID tag is associated to the specific identification number of the radiology shield (which is optionally also marked on the radiology shield), as discussed below. This allows the shield to be located and identified using the specific signature of the passive RFID Tag with a passive RFID reader, as also discussed below. Note that, while a plurality of radiology shields are shown as in a single room, they may be distributed among a plurality of different rooms or locations within a single building or facility (e.g., a hospital or other stationary or mobile medical and/or dental facility). Note also that, while shields may be “located” in the sense of having a known physical location, their specific or particular “identity” (distinguishing one shield and the history thereof from another) may nevertheless be unknown. Hence the term “located” as used herein is intended to be inclusive of “identifying” a shield.

Passive RFID tags are known. Examples include, but are not limited to, those described in U.S. Pat. Nos. 8,159,350; 7,965,186; and 7,806,332.

The “unique identifier” may be a simple ink or print marking (that is, a printed indicia) on the shield (of a letter, number, symbol, other indicia, or combination thereof), a symbol or device fastened directly or indirectly on the shield, etc. For example, the unique identifier may in some embodiments be the RFID tag itself, though it is generally preferred that the unique identifier be one amenable to visual inspection by a user. In one embodiment, the “unique identifier” may a printed indicia on the RFID tag housing.

An RFID reader, preferably a handheld or portable RFID reader 12 (e.g., a Motorola 3190 handheld RFID reader) with a display 14 such as a touch-screen display is provided, with programming for implementing the steps discussed below. Numerous such devices are known, or will be apparent to those skilled in the art based on the present disclosure. See, e.g., U.S. Pat. Nos. 8,228,189; 8,174,384; 7,737,824; 7,375,631; and 7,161,470. A “smart phone” or personal or tablet computer running suitable software (e.g., an “app”), with an added hardware or detection component connected directly or indirectly (e.g., “blue tooth” protocol) thereto, can be readily adapted to serve as the RFID reader if desired.

As one or more of the plurality of radiology shields are typically (though not always), stored in a shielded room 16, as they are typically stored in close proximity to a radiology apparatus such as an X-ray apparatus for which shielding is required. Hence, a local area network (LAN) antenna 18 may be provided in the room for communication with the controller (as discussed below). In the alternative, if the RFID reader is used in a location where the LAN is not available, updating of the controller and controller database with new information on the RFID reader can simply be delayed until the RFID reader is within range of the LAN, at which time the controller and database can be manually or automatically updated.

A controller such as a personal computer 20 with an operatively associated visual display 22 is also connected to the local area network for overall management of the system, as discussed below. Information concerning the status of inspections and for generating reports may be stored as a database on the memory of the personal computer. However, alternate system architectures may be used, such as remote or internet-based controllers and database/memory. As an alternative to a computer such as personal computer, a “smart phone” or tablet computer running suitable software (e.g., an “app”), can also be used, which may be the same as or different from the device serving as the RFID reader as discussed above.

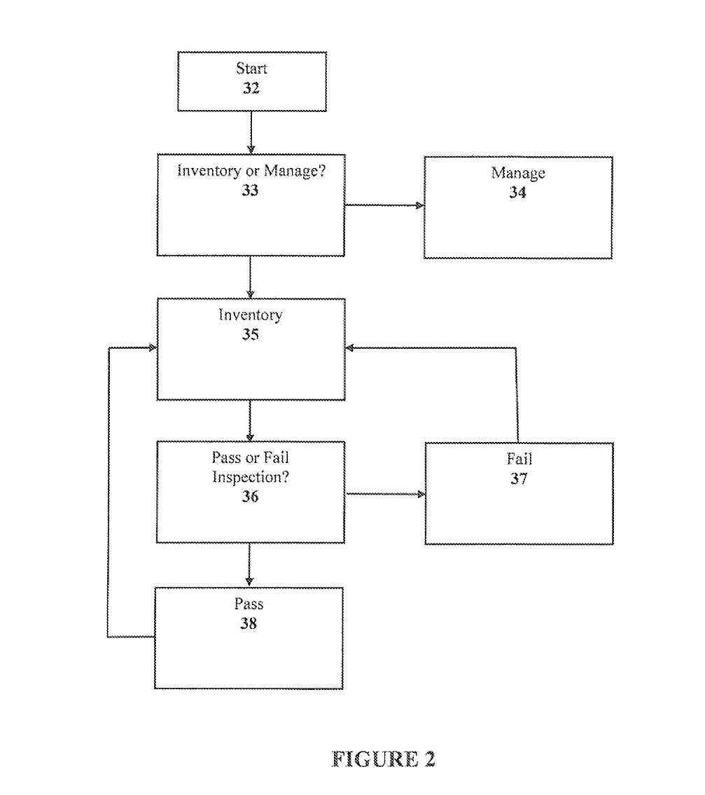

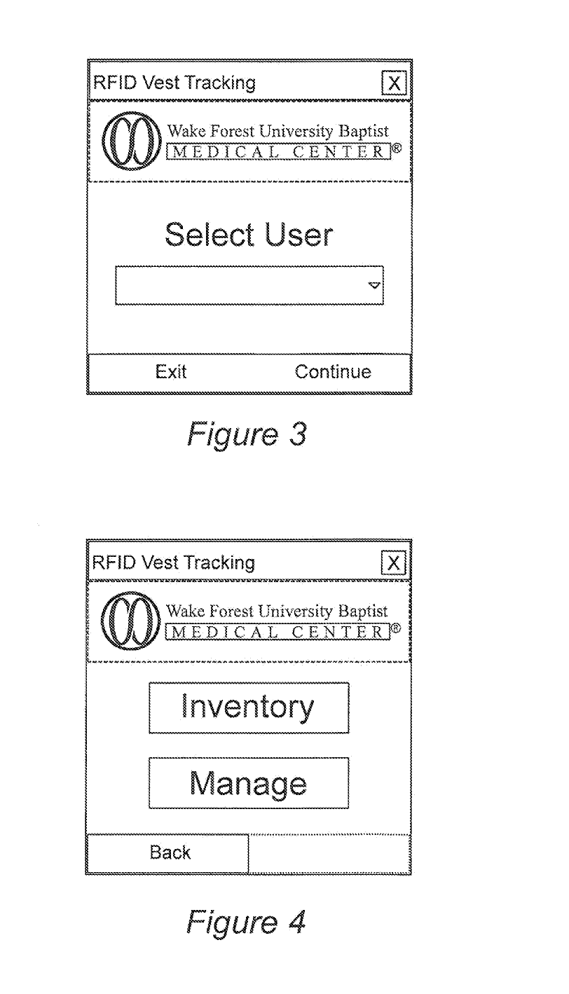

The operation of the system is schematically illustrated in FIG. 2 in association with the different RFID reader displays illustrated in FIGS. 3-7.

The process can be started 32 from a Start screen (illustrated in FIG. 3), which start screen is opened by any suitable technique, such as by clicking an icon on the touch-screen display of the RFID reader. From the start screen, an authorized “user” is selected from a preprogrammed set of available options from the drop down menu. Only after the authorized user is selected, does pressing the “Continue” button lead to the step of choosing the inventory steps or managing steps 33 from the inventory or manage screen (illustrated in FIG. 4).

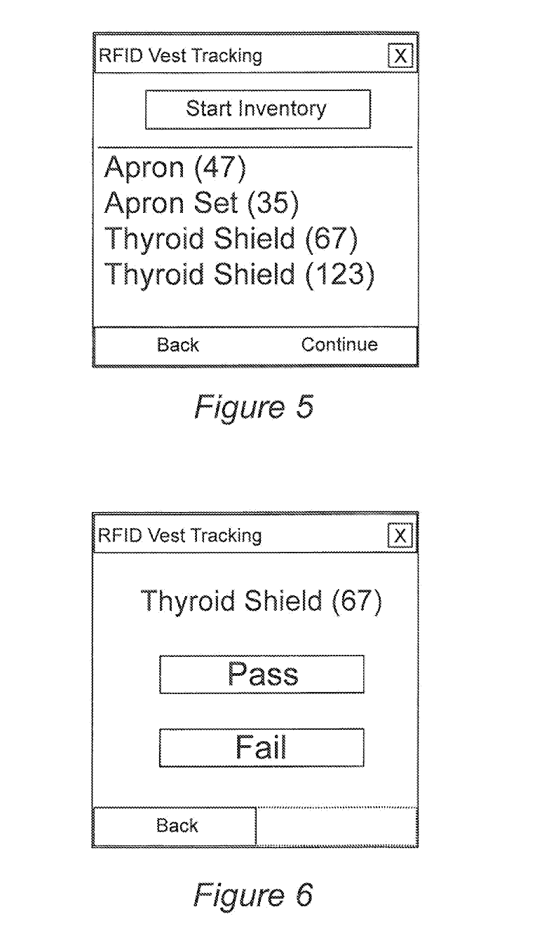

Activating the inventory button causes the inventory screen to be displayed, and activation of the “start inventory” button cases the RFID reader to detect all RFID shields within range and identify those shields by type and assigned identifier or number on the inventory screen of the RFID reader, as shown in FIG. 5. Where some but not all of the shields within range of the RFID reader have been inspected within the acceptable time period (that is, are not yet due for inspection), the reader can be programmed to automatically exclude them from the display. Where all of the shields within range have been inspected within the acceptable time period, a suitable display noting to the user that “shields found but inspection not required” (or the like) can be programmed to appear so that the user receives positive confirmation that the shields have been detected and and no inspections are required. Where one or more shields are displayed for inspection, an individual shield can be selected, which causes the pass or fail screen for that specific shield to appear, as illustrated in FIG. 6.

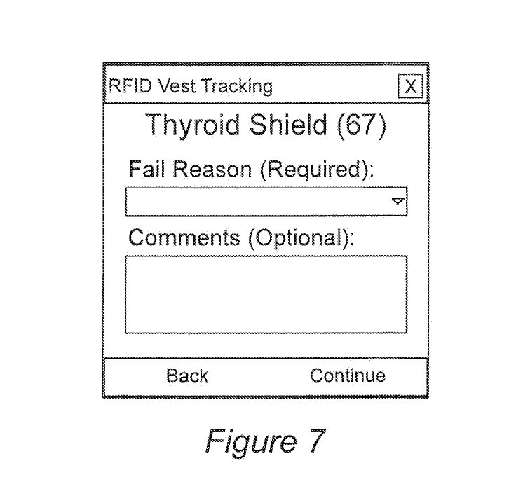

The authorized user conducts an inspection of the selected shield, and determines whether the selected shield passes or fails inspection. If the user selects “fail” then the fail screen is displayed, as illustrated in FIG. 7. A reason for the failure determination is then selected from a pull-down menu (for example, at least two, three, or four of: rip/ripped, tear/torn, crack/cracked, burn/burned, stain/stained, cut, hole/perforation (and including synonyms thereof), other, etc.). Optionally, comments upon the reason for failure can be entered. The “continue” button is depressed and the user returned to the inventory screen, with the shield for which a failure reason entered subtracted from the display. If, on the other hand, the user selects “pass” from the “pass or fail screen” for that particular shield, the inventory screen is simply redisplayed, with the shield for which “pass” has been entered subtracted from the display. Hence, the user can progress through an inspection of all radiology shields displayed on the inventory screen, with a “pass” or “fail” determination for each shield, until the inventory screen is empty. Once the inspection session is completed, the controller database is updated as discussed above. The database can be searched for historical information on a specific shield, or used to generate a report on some or all shields in a facility.

As noted above, the authorized user has the option of selecting a manage items screen from the inventory or manage screen. From this screen, depressing the “start scanning” button will search for available RFID tags (preferably, the tag is isolated so only one item at a time is managed). Once an RFID tag number is displayed on the screen, the user may depress “Stop Scanning.” Next, the user selects the particular RFID number and moves to a further manage screen, from which the user can enter information for the radiology shield associated, or to be associated, with that RFID tag, such as type of shield, number or identifier associated with that shield, department to which the shield is assigned, etc. Available options for each can be determined by the controller, as discussed below.

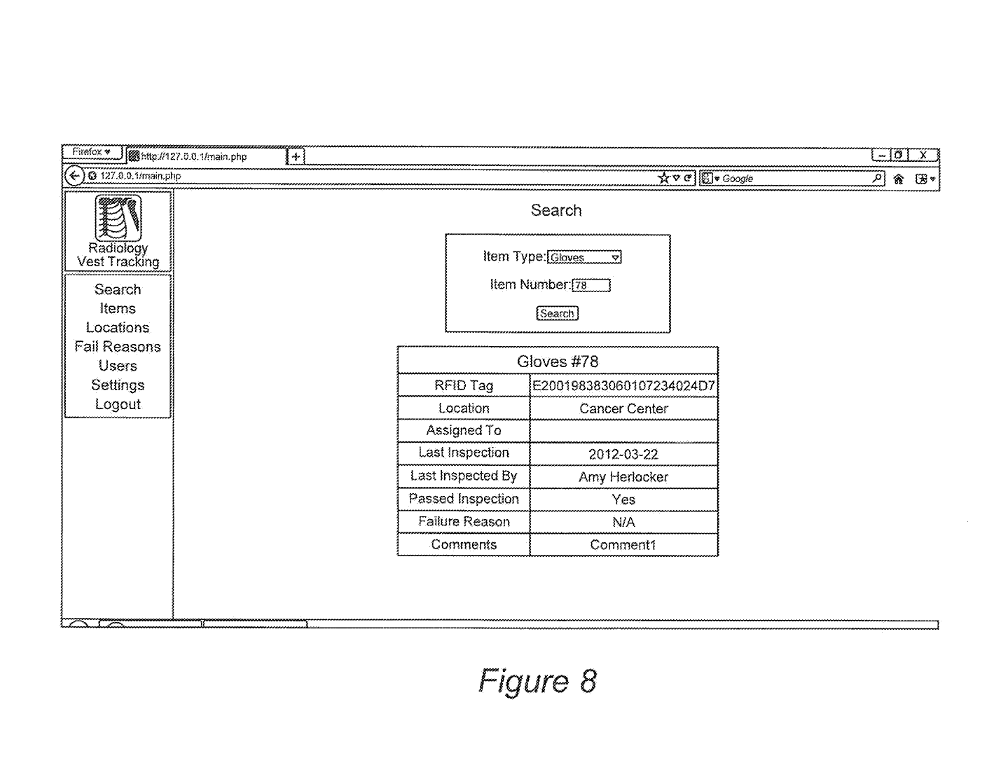

The controller, as noted above provides a database or access to a database for information received from the RFID reader. The database may receive from the RFID reader (e.g., through the LAN) information concerning each radiology shield, such as: time of last inspection, location of shield at last inspection, user conducting last inspection, pass or fail determination at last inspection, reason for failure at last inspection, etc. The controller also transmits update information to the RFID reader (e.g., through the LAN), such as the type and identification of each radiology shield associated with a particular RFID tag, authorized users, authorized fail options, etc. Updating of the RFID reader can be carried out manually or automatically. The controller may be provided with a plurality of selectable screens for display, such as illustrated in FIGS. 8-13.

FIG. 8 illustrates a “search” screen in which current information on a specific item may be retrieved.

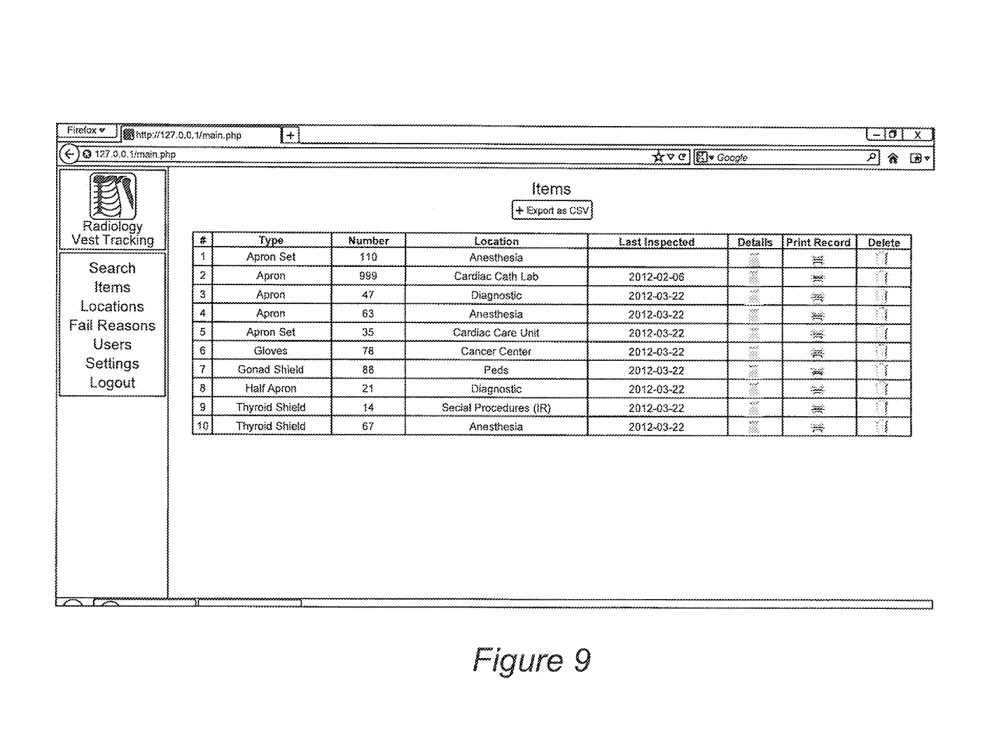

FIG. 9 illustrates an “items” screen from which an inventory of various items can be displayed, including highlighting of any items that require inspection.

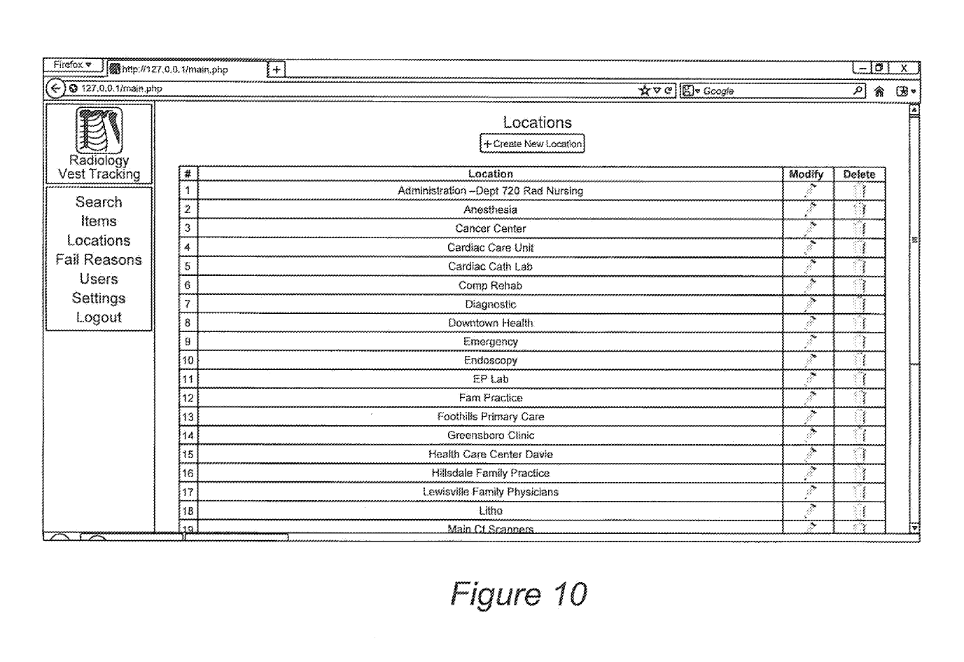

FIG. 10 illustrates a “locations” screen from which the available locations for which an item may be located can be entered. Particular (and generally pre-assigned) locations are stored in the main computer or central database, from which they are sent to the RFID reader. The RFID reader then uses the pre-assigned locations to specifically identify the location of the aprons.

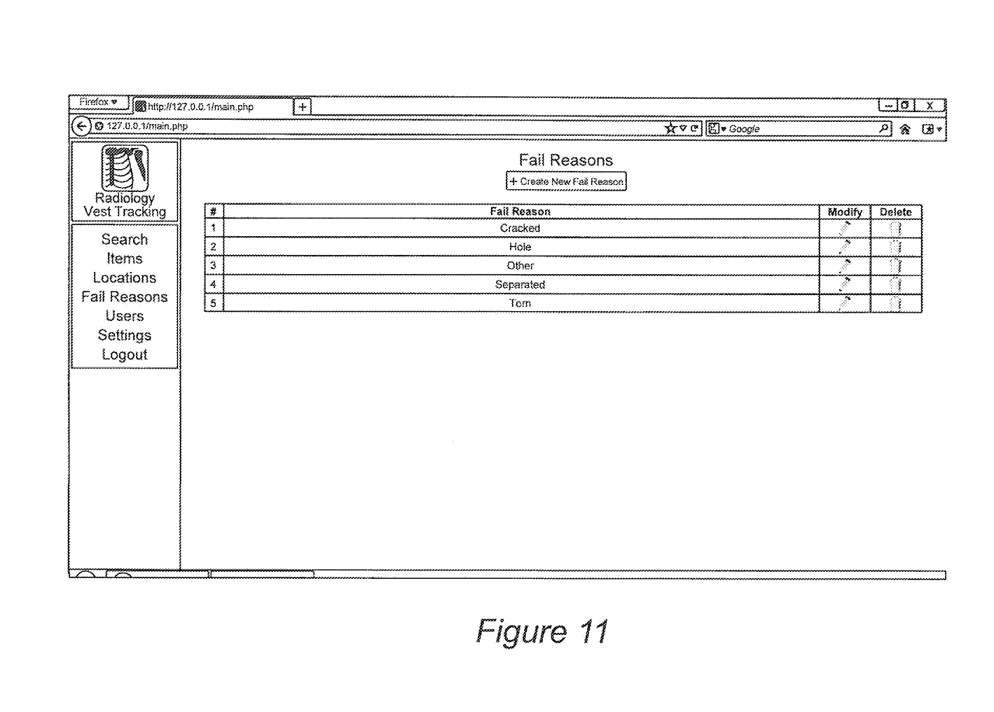

FIG. 11 illustrates a “fail reasons” screen from which the authorized reasons for failure to be displayed on the pull-down list in the RFID reader are entered.

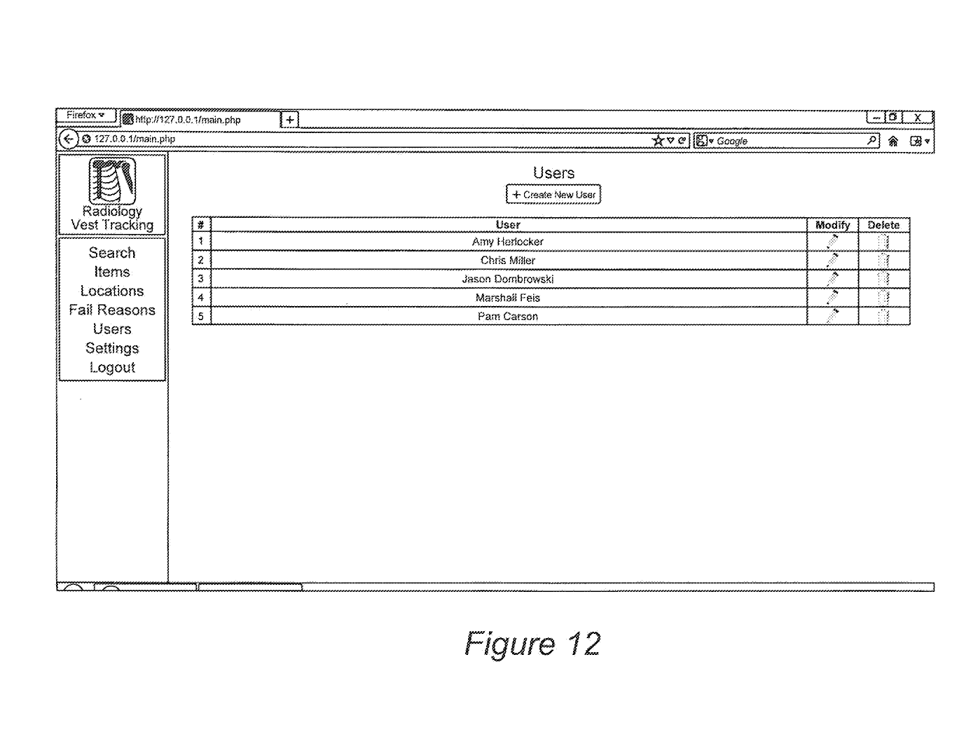

FIG. 12 illustrates a “users” screen from which the authorized users to be displayed on a pull-down list in the RFID reader are entered. As with “locations” the authorized users are pre-assigned in the main computer or central database, from which they are sent to the RFID reader so a particular user may log in as themselves to identify who carried out an inspection and entered information on a particular shield.

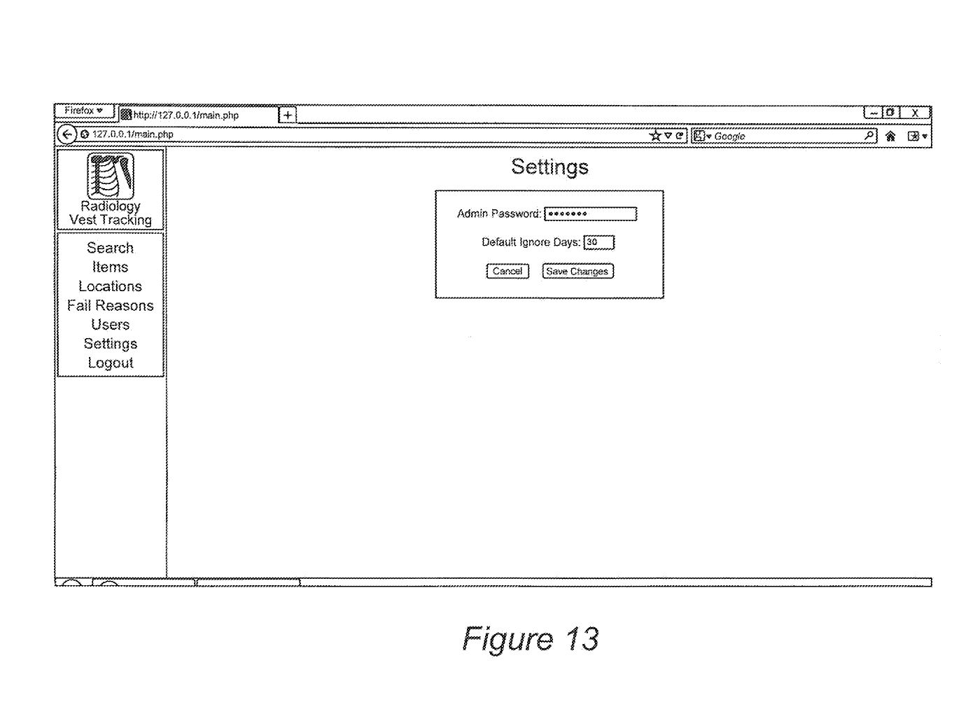

FIG. 13 illustrates a “settings” screen. The settings screen may be used to determine how far back in time the system will look for due dates for a particular inspection.

The foregoing is illustrative of the present invention, and is not to be construed as limiting thereof. The invention is defined by the following claims, with equivalents of the claims to be included therein.

1. A computer-implemented method for locating and inspecting radiology shields, comprising:
(a) providing a set of radiology shields, each of said radiology shields having a unique identifier thereon, and each of said radiology shields carrying a passive RFID tag, said passive RFID tag associated with said unique identifier;
(b) providing a central database, said database comprising common data and individual shield data, said common data comprising:
(i) an inspection time interval for said radiology shields, and
(ii) authorized users for said method;
and said individual shield data comprising, for each of said radiology shields:
(i′) the unique identifier for said radiology shield;
(ii′) the RFID tag associated with said radiology shield;
(iii′) a date of last inspection for said radiology shield; and
(iv′) a pass or fail inspection determination for said radiology shield at said last inspection;
(c) transmitting said common data and individual shield data for at least shields to be inspected to a portable RPM reader;
(d) identifying, with said portable RFID reader, shields to be inspected based on said inspection time interval and said data of last inspection;
(e) entering a determination of pass or fail inspection into said portable RFID reader for each of said shields to be inspected; and then
(f) updating said central database individual shield data for each of said shields to be inspected from said portable RFID reader.

2. The method of claim 1, wherein said radiology shields are stored in a plurality of different locations within a common medical facility.

3. The method of claim 1, wherein said radiology shields are stored in a plurality of different locations at a plurality of different medical facilities.

4. The method of claim 1, said common data further comprising:
(iii) pre-assigned locations for said radiology shields within a medical facility;
(iv) a set of types of radiology shields; and/or
(v) a set of inspection failure reasons.

5. The method of claim 1, said shield data further comprising:
(v′) the last location of said radiology shield;
(vi′) the last inspector of said radiology shield; and/or
(vii′) the reason if any for a fail inspection determination for said radiology shield.

6. The method of claim 1, wherein said set of radiology shields comprise vests, skirts, aprons, apron sets, half aprons, gloves, goggles, glasses, face masks or screens, gonad shields, thyroid shields, or combinations thereof.

7. The method of claim 4, wherein said set of types comprises at least two of vests, skirts, aprons, apron sets, half aprons, gloves, goggles, glasses, face masks or screens, gonad shields, and thyroid shields.

8. The method of claim 4, wherein said set of inspection failure reasons comprises at least two, three or four of: rip/ripped, tear/torn, crack/cracked, burn/burned, stain/stained, cut, and hole/perforation.

9. The method of claim 1, wherein said transmitting step is carried out over wireless network, preferably a local area network.

10. The method of claim 1, further comprising the step on (g) generating a report on said set of shields from said central database.

11. The method of claim 10, said report comprising, for each of said shields:
a date of last inspection for said radiology shield; and
a pass or fail inspection determination for said radiology shields at said last inspection.

12. A system for locating and inspecting radiology shields, comprising:
(a) a set of radiology shields, each of said radiology shields having a unique identifier thereon, and each of said radiology shields carrying a passive RFID tag, said passive RFID tag associated with said unique identifier;
(b) a central database, said database comprising common data and individual shield data, said common data comprising:
(i) an inspection time interval for said radiology shields, and
(ii) authorized users for said method;
and said individual shield data comprising, for each of said radiology shields:
(i′) the unique identifier for said radiology shield;
(ii′) the RFID tag associated with said radiology shield;
(iii′) a date of last inspection for said radiology shield; and
(iv′) a pass or fail inspection determination for said radiology shield at said last inspection;
(c) a portable RFID reader;
(d) means for transmitting said common data and individual shield data for at least shields to be inspected to a portable RFID reader;
(d) means for identifying, with said portable RFID reader, shields to be inspected based on said inspection time interval and said data of last inspection;
(e) means for entering a determination of pass or fail inspection into said portable RFID reader for each of said shields to be inspected; and
(f) means for updating said central database individual shield data for each of said shields to be inspected from said portable RFID reader.

13. The system of claim 12, wherein said radiology shields are stored in a plurality of different locations within a common medical facility.

14. The system of claim 12, wherein said radiology shields are stored in a plurality of different locations at a plurality of different medical facilities.

15. The system of claim 12, said common data further comprising:
(iii) pre-assigned locations for said radiology shields within a medical facility;
(iv) a set of types of radiology shields; and/or
(v) a set of inspection failure reasons.

16. The system of claim 12, said shield data further comprising:
(v′) the last location of said radiology shield;
(vi′) the last inspector of said radiology shield; and/or
(vii′) the reason if any for a fail inspection determination for said radiology shield.

17. The system of claim 15, wherein said set of radiology shields comprise vests, skirts, aprons, apron sets, half aprons, gloves, goggles, glasses, face masks or screens, gonad shields, thyroid shields, or combinations thereof.

18. The system of claim 15, wherein said set of types comprises at least two of vests, skirts, aprons, apron sets, half aprons, gloves, goggles, glasses, face masks or screens, gonad shields, and thyroid shields.

19. The system of claim 15, wherein said set of inspection failure reasons comprises at least two, three or four of rip/ripped, tear/torn, crack/cracked, burn/burned, stain/stained, cut, and hole/perforation.

20. The system of claim 12, wherein said transmitting step is carried out over wireless network, preferably a local area network.

21. The system of claim 12, further comprising:
(g) means for generating a report on said set of shields from said central database.

22. The system of claim 21, said report comprising, for each of said shields:
a date of last inspection for said radiology shield; and
a pass or fail inspection determination for said radiology shields at said last inspection.
